(19) United States
(12) Patent Application Publication
(10) Pub. No.: US 2025/0219146 A1
(43) Pub. Date: Jul. 3, 2025

(54) POWER STORAGE ELEMENT

(71) Applicant: TDK Corporation, Tokyo (JP)

(72) Inventors: Keitaro OTSUKI, Tokyo (JP); Shinichiro KAKEI, Tokyo (JP)

(73) Assignee: TDK Corporation, Tokyo (JP)

(21) Appl. No.: 19/086,161

(22) Filed: Mar. 21, 2025

Related U.S. Application Data
(63) Continuation of application No. PCT/JP2023/011555, filed on Mar. 23, 2023.

(51) Int. Cl. H01M 10/0567; H01M 4/36; H01M 4/505; H01M 4/525; H01M 10/0568

(52) U.S. Cl. CPC H01M 10/0567; H01M 4/364; H01M 4/505; H01M 4/525; H01M 10/0568

(57) ABSTRACT

A power storage element includes a positive electrode, a negative electrode, a separator, and an electrolyte solution. A content Vemc of ethyl methyl carbonate in the electrolyte solution is 26.5 to 45.0 vol %. A content Vec of ethylene carbonate in the electrolyte solution is 9.0 to 33.5 vol %. A content Vdmc of dimethyl carbonate in the electrolyte solution is 29.5 to 41.0 vol %. A content Vdec of diethyl carbonate in the electrolyte solution is 0.0 to 0.2 vol %. A content Vpc of propylene carbonate in the electrolyte solution is 0.0 to 10.5 vol %. A content Vfec of fluoroethylene carbonate in the electrolyte solution is 0.0 vol % or more. A sum of the Vemc, the Vec, the Vdmc, the Vdec, the Vpc, and the Vfec is 97.0 to 100 vol %.

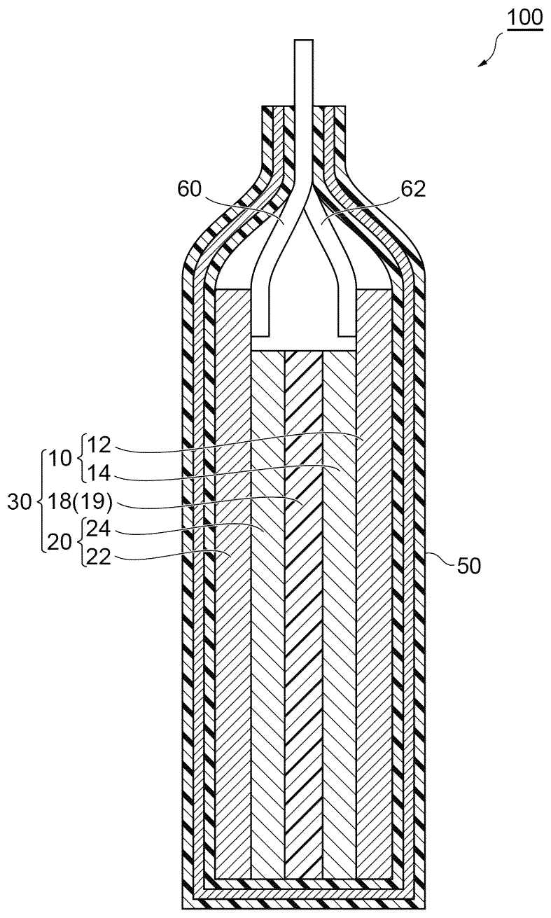

### CROSS-REFERENCE TO RELATED APPLICATION

The present application is a continuation of PCT/JP2023/011555, filed on Mar. 23, 2023, the entire contents of which are incorporated herein by reference.

### TECHNICAL FIELD

The present disclosure relates to a power storage element.

### BACKGROUND

Power storage elements (electricity storage devices) such as lithium-ion secondary batteries are widely used as power sources for mobile devices such as mobile phones and notebook computers, hybrid cars, and the like. In recent years, demand for large-sized power storage elements used in stationary power storage devices, electric vehicles, and the like has increased, and power storage elements may have high performance for achieving both high capacity and safety.

The capacity of a lithium-ion secondary battery using lithium cobaltate (LiCoO₂) as a positive electrode active material is high and the lithium cobaltate is easily synthesized, and lithium cobaltate may be widely used as the positive electrode active material. However, the production areas of cobalt are limited and the market price of cobalt is high, and materials in which a part of cobalt in the lithium cobaltate is replaced with nickel or manganese have been considered. For example, the capacity may increase due to the replacement of cobalt with nickel, Li(Ni, Co)O₂, e.g., in which a part of cobalt in the lithium cobaltate is replaced with nickel, has been considered as an alternative material for lithium cobaltate.

As the amount of nickel replacing cobalt increases, Li(Ni, Co)O₂ exhibits properties close to those of lithium nickelate (LiNiO₂). For example, as the amount of nickel replacing cobalt increases, a structure of Li(Ni, Co)O₂ could become unstable, and cycle characteristics, temperature characteristics, and the like of the lithium-ion secondary battery could be deteriorated.

The following Patent Literature 1 discloses a nonaqueous secondary battery in which a positive electrode active material layer contains Li(Ni, Mn, Co)O₂, the porosity of each of the positive electrode active material layer and the negative electrode active material layer is within a specific range, and the air permeability of a separator is also within a specific range, and which contains an electrolyte solution containing at least one selected from the group consisting of dimethyl carbonate, ethyl methyl carbonate, and diethyl carbonate, and ethylene carbonate. It is disclosed in Patent Literature 1 that the nonaqueous secondary battery having these features has excellent charging/discharging characteristics at a large current and a high capacity.

The following Patent Literature 2 discloses a nonaqueous secondary battery including a positive electrode containing Li(Ni, Mn, Co)O₂, a negative electrode containing graphite, and a nonaqueous solvent in which the volume ratio and total of ethylene carbonate and ethyl methyl carbonate are within a specific range. It is disclosed in Patent Literature 2 that the nonaqueous secondary battery having these features is excellent in rapid charging/discharging characteristics, charging/discharging cycle characteristics, and storage characteristics.

### CITATION LIST

### Patent Literature

Patent Literature 1: WO 2015/041167 A
Patent Literature 2: WO 2015/037522 A

### SUMMARY

However, there is room for improvement in cycle characteristics at a high temperature of a power storage element.

One or more embodiments may provide a power storage element excellent in cycle characteristics.

### SOLUTIONS

For example, one aspect of the present disclosure relates to the following power storage element.

[1]A power storage element including:
a positive electrode;
a negative electrode;
a separator; and
an electrolyte solution, wherein
the positive electrode includes a first current collector and a first active material layer covering at least a part of a main surface of the first current collector,
the negative electrode includes a second current collector and a second active material layer covering at least a part of a main surface of the second current collector,
the first active material layer and the second active material layer face each other,
the separator is a porous insulator, and is disposed between the first active material layer and the second active material layer,
the separator is impregnated with the electrolyte solution, and the electrolyte solution is in contact with the first active material layer and the second active material layer,
a content Vemc of ethyl methyl carbonate (1) in the electrolyte solution is 26.5 vol % or more and 45.0 vol % or less,
a content Vec of ethylene carbonate (2) in the electrolyte solution is 9.0 vol % or more and 33.5 vol % or less,
a content Vdmc of dimethyl carbonate (3) in the electrolyte solution is 29.5 vol % or more and 41.0 vol % or less,
a content Vdec of diethyl carbonate (4) in the electrolyte solution is 0.0 vol % or more and 0.2 vol % or less,
a content Vpc of propylene carbonate (5) in the electrolyte solution is 0.0 vol % or more and 10.5 vol % or less,
a content Vfec of fluoroethylene carbonate (8) in the electrolyte solution is 0.0 vol % or more, and
a sum of the Vemc, the Vec, the Vdmc, the Vdec, the Vpc, and the Vfec is 97.0 vol % or more and 100 vol % or less.

[2] The power storage element according to [1], wherein
the Vemc is 27.0 vol % or more and 31.0 vol % or less,
the Vec is 29.0 vol % or more and 33.0 vol % or less,
the Vdmc is 37.0 vol % or more and 41.0 vol % or less,
the Vdec is 0.02 vol % or more and 0.20 vol % or less, and
a sum of the Vemc, the Vec, the Vdmc, and the Vdec is 97.0 vol % or more and 100 vol % or less.

[3] The power storage element according to [2], wherein the Vemc is smaller than the Vec.

[4] The power storage element according to [2] or [3], wherein
a content of vinylene carbonate (6) in the electrolyte solution is 0.03 mass % or more and 0.20 mass % or less.

[5] The power storage element according to any one of [2] to [4], wherein
a content of propane sultone (7) in the electrolyte solution is 0.05 mass % or more and 0.20 mass % or less.

[6] The power storage element according to [1], wherein
the Vemc is 40.5 vol % or more and 44.5 vol % or less,
the Vec is 9.3 vol % or more and 13.3 vol % or less,
the Vdmc is 29.5 vol % or more and 33.5 vol % or less,
the Vpc is 4.0 vol % or more and 8.0 vol % or less,
the Vfec is 6.2 vol % or more and 10.8 vol % or less, and
a sum of the Vemc, the Vec, the Vdmc, the Vpc, and the Vfec is 97.0 vol % or more and 100 vol % or less.

[7] The power storage element according to [6], wherein
a content of vinylene carbonate (6) in the electrolyte solution is 0.01 mass % or more and 0.10 mass % or less.

[8] The power storage element according to [6] or [7], wherein
a content of adiponitrile (9) in the electrolyte solution is 0.70 mass % or more and 4.70 mass % or less.

[9] The power storage element according to [1], wherein
an electrolyte in the electrolyte solution contains lithium hexafluorophosphate, and
a total concentration of the electrolyte in the electrolyte solution is 1.05 mol/L or more and 1.60 mol/L or less.

[10] The power storage element according to [1], wherein
an electrolyte in the electrolyte solution contains lithium hexafluorophosphate, and
a total concentration of the electrolyte in the electrolyte solution is 1.21 mol/L or more and 1.41 mol/L or less.

[11] The power storage element according to any one of [2] to [5], wherein
an electrolyte in the electrolyte solution contains lithium hexafluorophosphate, and
a total concentration of the electrolyte in the electrolyte solution is 1.05 mol/L or more and 1.20 mol/L or less.

[12] The power storage element according to any one of [6] to [8], wherein
an electrolyte in the electrolyte solution contains lithium hexafluorophosphate, and
a total concentration of the electrolyte in the electrolyte solution is 1.42 mol/L or more and 1.60 mol/L or less.

[13] The power storage element according to [1], wherein
the first active material layer included in the positive electrode includes a metal oxide,
the metal oxide contains lithium, nickel, manganese, and cobalt,
an amount of nickel in the metal oxide is expressed as [Ni] mol,
an amount of manganese in the metal oxide is expressed as [Mn] mol,
an amount of cobalt in the metal oxide is expressed as [Co] mol,
among the [Ni], the [Mn], and the [Co], the [Ni] is largest,
[Ni]/[Mn] is 1.55 or more and 2.15 or less, and
[Ni]/[Co] is 2.20 or more and 2.60 or less.

[14] The power storage element according to any one of [2] to [5] and [11], wherein
the first active material layer included in the positive electrode includes a metal oxide,
the metal oxide contains lithium, nickel, manganese, and cobalt,
an amount of nickel in the metal oxide is expressed as [Ni] mol,
an amount of manganese in the metal oxide is expressed as [Mn] mol,
an amount of cobalt in the metal oxide is expressed as [Co] mol,
among the [Ni], the [Mn], and the [Co], the [Ni] is largest,
[Ni]/[Mn] is 1.67 or more and 1.84 or less, and
[Ni]/[Co] is 2.21 or more and 2.41 or less.

[15] The power storage element according to [14], wherein
the first active material layer included in the positive electrode further contains titanium and zirconium.

[16] The power storage element according to [15], wherein
a content of titanium in the first active material layer is 0.084 mol % or more and 0.184 mol % or less in terms of TiO₂.

[17] The power storage element according to [15] or [16], wherein
a content of zirconium in the first active material layer is 0.095 mol % or more and 0.195 mol % or less in terms of ZrO₂.

[18] The power storage element according to any one of [6] to [8] and [12], wherein
the first active material layer included in the positive electrode includes a metal oxide,
the metal oxide contains lithium, nickel, manganese, and cobalt,
an amount of nickel in the metal oxide is expressed as [Ni] mol,
an amount of manganese in the metal oxide is expressed as [Mn] mol,
an amount of cobalt in the metal oxide is expressed as [Co] mol,
among the [Ni], the [Mn], and the [Co], the [Ni] is largest,
[Ni]/[Mn] is 1.95 or more and 2.15 or less, and
[Ni]/[Co] is 2.38 or more and 2.58 or less.

[19] The power storage element according to any one of [13] to [18], wherein
the first active material layer included in the positive electrode further contains at least one element selected from the group consisting of sodium, aluminum, chlorine, phosphorus, and sulfur.

[20] The power storage element according to [1], wherein
the first active material layer included in the positive electrode includes a metal oxide,
the metal oxide contains lithium, nickel, manganese, and cobalt,
an amount of nickel in the metal oxide is expressed as [Ni] mol,
an amount of manganese in the metal oxide is expressed as [Mn] mol,
an amount of cobalt in the metal oxide is expressed as [Co] mol,
among the [Ni], the [Mn], and the [Co], the [Ni] is largest,
[Ni]/[Mn] is 3.00 or more and 8.00 or less, and
[Ni]/[Co] is 3.00 or more and 8.00 or less.

[21] The power storage element according to any one of [1] to [8], wherein
the power storage element is a lithium-ion secondary battery, a sodium-ion secondary battery, a potassium-ion secondary battery, a magnesium-ion secondary battery, or a calcium-ion secondary battery.

### Advantageous Effects

According to one aspect of the present disclosure, there is provided a power storage element excellent in cycle characteristics.

### BRIEF DESCRIPTION OF DRAWING

The FIGURE illustrates a schematic cross section of a power storage element (lithium-ion secondary battery) according to an embodiment of the present disclosure, and the cross section illustrated in the FIGURE is substantially perpendicular to main surfaces of a positive electrode, a negative electrode, and a separator.

### DESCRIPTION OF EMBODIMENTS

For example, one aspect of the present disclosure relates to the following power storage element.

[1]A power storage element including:
a positive electrode;
a negative electrode;
a separator; and
an electrolyte solution, wherein
the positive electrode includes a first current collector and a first active material layer covering at least a part of a main surface of the first current collector,
the negative electrode includes a second current collector and a second active material layer covering at least a part of a main surface of the second current collector,
the first active material layer and the second active material layer face each other,
the separator is a porous insulator, and is disposed between the first active material layer and the second active material layer,
the separator is impregnated with the electrolyte solution, and the electrolyte solution is in contact with the first active material layer and the second active material layer,
a content Vemc of ethyl methyl carbonate (1) in the electrolyte solution is 26.5 vol % or more and 45.0 vol % or less,
a content Vec of ethylene carbonate (2) in the electrolyte solution is 9.0 vol % or more and 33.5 vol % or less,
a content Vdmc of dimethyl carbonate (3) in the electrolyte solution is 29.5 vol % or more and 41.0 vol % or less,
a content Vdec of diethyl carbonate (4) in the electrolyte solution is 0.0 vol % or more and 0.2 vol % or less,
a content Vpc of propylene carbonate (5) in the electrolyte solution is 0.0 vol % or more and 10.5 vol % or less,
a content Vfec of fluoroethylene carbonate (8) in the electrolyte solution is 0.0 vol % or more, and
a sum of the Vemc, the Vec, the Vdmc, the Vdec, the Vpc, and the Vfec is 97.0 vol % or more and 100 vol % or less.

[2] The power storage element according to [1], wherein
the Vemc is 27.0 vol % or more and 31.0 vol % or less,
the Vec is 29.0 vol % or more and 33.0 vol % or less,
the Vdmc is 37.0 vol % or more and 41.0 vol % or less,
the Vdec is 0.02 vol % or more and 0.20 vol % or less, and
a sum of the Vemc, the Vec, the Vdmc, and the Vdec is 97.0 vol % or more and 100 vol % or less.

[3] The power storage element according to [2], wherein
the Vemc is smaller than the Vec.

[4] The power storage element according to [2] or [3], wherein
a content of vinylene carbonate (6) in the electrolyte solution is 0.03 mass % or more and 0.20 mass % or less.

[5] The power storage element according to any one of [2] to [4], wherein
a content of propane sultone (7) in the electrolyte solution is 0.05 mass % or more and 0.20 mass % or less.

[6] The power storage element according to [1], wherein
the Vemc is 40.5 vol % or more and 44.5 vol % or less,
the Vec is 9.3 vol % or more and 13.3 vol % or less,
the Vdmc is 29.5 vol % or more and 33.5 vol % or less,
the Vpc is 4.0 vol % or more and 8.0 vol % or less,
the Vfec is 6.2 vol % or more and 10.8 vol % or less, and
a sum of the Vemc, the Vec, the Vdmc, the Vpc, and the Vfec is 97.0 vol % or more and 100 vol % or less.

[7] The power storage element according to [6], wherein
a content of vinylene carbonate (6) in the electrolyte solution is 0.01 mass % or more and 0.10 mass % or less.

[8] The power storage element according to [6] or [7], wherein
a content of adiponitrile (9) in the electrolyte solution is 0.70 mass % or more and 4.70 mass % or less.

[9] The power storage element according to [1], wherein
an electrolyte in the electrolyte solution contains lithium hexafluorophosphate, and
a total concentration of the electrolyte in the electrolyte solution is 1.05 mol/L or more and 1.60 mol/L or less.

[10] The power storage element according to [1], wherein
an electrolyte in the electrolyte solution contains lithium hexafluorophosphate, and
a total concentration of the electrolyte in the electrolyte solution is 1.21 mol/L or more and 1.41 mol/L or less.

[11] The power storage element according to any one of [2] to [5], wherein
an electrolyte in the electrolyte solution contains lithium hexafluorophosphate, and
a total concentration of the electrolyte in the electrolyte solution is 1.05 mol/L or more and 1.20 mol/L or less.

[12] The power storage element according to any one of [6] to [8], wherein
an electrolyte in the electrolyte solution contains lithium hexafluorophosphate, and
a total concentration of the electrolyte in the electrolyte solution is 1.42 mol/L or more and 1.60 mol/L or less.

[13] The power storage element according to [1], wherein
the first active material layer included in the positive electrode includes a metal oxide,
the metal oxide contains lithium, nickel, manganese, and cobalt,
an amount of nickel in the metal oxide is expressed as [Ni] mol,
an amount of manganese in the metal oxide is expressed as [Mn] mol,
an amount of cobalt in the metal oxide is expressed as [Co] mol,
among the [Ni], the [Mn], and the [Co], the [Ni] is largest,
[Ni]/[Mn] is 1.55 or more and 2.15 or less, and
[Ni]/[Co] is 2.20 or more and 2.60 or less.

[14] The power storage element according to any one of [2] to [5] and [11], wherein
the first active material layer included in the positive electrode includes a metal oxide,
the metal oxide contains lithium, nickel, manganese, and cobalt,
an amount of nickel in the metal oxide is expressed as [Ni] mol,
an amount of manganese in the metal oxide is expressed as [Mn] mol,
an amount of cobalt in the metal oxide is expressed as [Co] mol,
among the [Ni], the [Mn], and the [Co], the [Ni] is largest,
[Ni]/[Mn] is 1.67 or more and 1.84 or less, and
[Ni]/[Co] is 2.21 or more and 2.41 or less.

[15] The power storage element according to [14], wherein
the first active material layer included in the positive electrode further contains titanium and zirconium.

[16] The power storage element according to [15], wherein
a content of titanium in the first active material layer is 0.084 mol % or more and 0.184 mol % or less in terms of TiO₂.

[17] The power storage element according to [15] or [16], wherein
a content of zirconium in the first active material layer is 0.095 mol % or more and 0.195 mol % or less in terms of ZrO₂.

[18] The power storage element according to any one of [6] to [8] and [12], wherein
the first active material layer included in the positive electrode includes a metal oxide,
the metal oxide contains lithium, nickel, manganese, and cobalt,
an amount of nickel in the metal oxide is expressed as [Ni] mol,
an amount of manganese in the metal oxide is expressed as [Mn] mol,
an amount of cobalt in the metal oxide is expressed as [Co] mol,
among the [Ni], the [Mn], and the [Co], the [Ni] is largest,
[Ni]/[Mn] is 1.95 or more and 2.15 or less, and
[Ni]/[Co] is 2.38 or more and 2.58 or less.

[19] The power storage element according to any one of [13] to [18], wherein
the first active material layer included in the positive electrode further contains at least one element selected from the group consisting of sodium, aluminum, chlorine, phosphorus, and sulfur.

[20] The power storage element according to [1], wherein
the first active material layer included in the positive electrode includes a metal oxide,
the metal oxide contains lithium, nickel, manganese, and cobalt,
an amount of nickel in the metal oxide is expressed as [Ni] mol,
an amount of manganese in the metal oxide is expressed as [Mn]mol,
an amount of cobalt in the metal oxide is expressed as [Co] mol,
among the [Ni], the [Mn], and the [Co], the [Ni] is largest,
[Ni]/[Mn] is 3.00 or more and 8.00 or less, and
[Ni]/[Co] is 3.00 or more and 8.00 or less.

[21] The power storage element according to any one of [1] to [8], wherein
the power storage element is a lithium-ion secondary battery, a sodium-ion secondary battery, a potassium-ion secondary battery, a magnesium-ion secondary battery, or a calcium-ion secondary battery.

Hereinafter, as an embodiment of the present disclosure, a lithium-ion secondary battery which is a kind of power storage element will be described with reference to the drawings. The present disclosure is not limited to the following embodiments.

### (Outline of Lithium-Ion Secondary Battery)

As illustrated in the FIGURE, a lithium-ion secondary battery 100 according to the present embodiment may include a positive electrode 10, a negative electrode 20, a separator 18, an electrolyte solution 19, a positive electrode lead 62, a negative electrode lead 60, and a case 50. The positive electrode 10, the negative electrode 20, the separator 18, and the electrolyte solution 19 may constitute one power storage unit 30. The case 50 housing the power storage unit 30 may be sealed. The power storage unit 30 may be electrically insulated from an inner wall of the case 50. The positive electrode lead 62 and the negative electrode lead 60 may be electrically insulated from each other and are electrically insulated from the case 50. Each of the positive electrode 10, the negative electrode 20, and the separator 18 may be a plate, a layer, a laminate, or a thin film. The lithium-ion secondary battery 100 may include a plurality of power storage units 30.

The positive electrode 10 may include a first current collector 12 (positive electrode current collector) and a first active material layer 14 (positive electrode active material layer) covering a part or the whole of a main surface of the first current collector 12. The first active material layer 14 may cover only one of a pair of main surfaces (front surface and back surface) of the first current collector 12. The first active material layer 14 may cover both of the pair of main surfaces of the first current collector 12. The “main surface” is a surface having a largest area among a plurality of surfaces of a polyhedron (for example, the first current collector 12). A first end of the positive electrode lead 62 may be electrically connected to the positive electrode 10 (first current collector 12), and a second end of the positive electrode lead 62 may be outside the case 50.

The negative electrode 20 may include a second current collector 22 (negative electrode current collector) and a second active material layer 24 (negative electrode active material layer) covering a part or the whole of a main surface of the second current collector 22. The second active material layer 24 may cover only one of a pair of main surfaces (front surface and back surface) of the second current collector 22. The second active material layer 24 may cover both of the pair of main surfaces of the second current collector 22. One end of the negative electrode lead 60 may be electrically connected to the negative electrode 20 (second current collector 22), and the other end of the negative electrode lead 60 may be outside the case 50.

The first active material layer 14 and the second active material layer 24 may face each other. The separator 18 may be a porous insulator and may be between the first active material layer 14 and the second active material layer 24. In an implementation, the separator 18 may be sandwiched between the positive electrode 10 and the negative electrode 20 to separate the positive electrode 10 and the negative electrode 20. The separator 18 may be impregnated with the electrolyte solution 19 and the electrolyte solution 19 may be in contact with the first active material layer 14 and the second active material layer 24. The electrolyte solution 19 and the electrolyte in the electrolyte solution 19 may pass through the separator 18 through holes formed in the separator 18.

Feature (A): a content Vemc of ethyl methyl carbonate (1) in the electrolyte solution 19 may be 26.5 vol % or more and 45.0 vol % or less.

Feature (B): a content Vec of ethylene carbonate (2) in the electrolyte solution 19 may be 9.0 vol % or more and 33.5 vol % or less.

Feature (C): a content Vdmc of dimethyl carbonate (3) in the electrolyte solution 19 may be 29.5 vol % or more and 41.0 vol % or less.

Feature (D): a content Vdec of diethyl carbonate (4) in the electrolyte solution 19 may be 0.0 vol % or more and 0.2 vol % or less.

Feature (E): a content Vpc of propylene carbonate (5) in the electrolyte solution 19 may be 0.0 vol % or more and 10.5 vol % or less.

Feature (F): a content Vfec of fluoroethylene carbonate (8) in the electrolyte solution 19 may be 0.0 vol % or more.

Feature (G): a sum of Vemc, Vec, Vdmc, Vdec, Vpc, and Vfec may be 97.0 vol % or more and 100 vol % or less.

In the present disclosure, symbols Vemc, Vec, Vdmc, Vdec, Vpc, and Vfec are used to simplify the description of the composition of the electrolyte solution 19.

Any of ethyl methyl carbonate (1), ethylene carbonate (2), dimethyl carbonate (3), diethyl carbonate (4), propylene carbonate (5), and fluoroethylene carbonate (8) is an organic solvent (nonaqueous solvent) that dissolves an electrolyte.

In an implementation, the sum of Vemc, Vec, Vdmc, Vdec, Vpc, and Vfec may be less than 100 vol %, and the remainder (e.g., obtained by removing ethyl methyl carbonate (1), ethylene carbonate (2), dimethyl carbonate (3), diethyl carbonate (4), propylene carbonate (5), and fluoroethylene carbonate (8) from the electrolyte solution 19) may include other organic solvents, electrolytes, various additives, or inevitable impurities. In an implementation, the electrolyte solution 19 may further include an additive, e.g., vinylene carbonate (6), propane sultone (7), or adiponitrile (9).

In an implementation, the electrolyte solution 19 may have the features (A), (B), (C), (D), (E), (F) and (G), and the cycle characteristics of the lithium-ion secondary battery 100 used at a high temperature (for example, a temperature of 60° C. or higher) may be improved. The cycle characteristics are a property of suppressing a decrease in capacity associated with repeated charging/discharging of the lithium-ion secondary battery 100. The cycle characteristics may be paraphrased or described as a capacity retention rate. The improvement in the cycle characteristics may be paraphrased or described as an increase in the capacity retention rate. In an implementation, Vfec may be 0.0 vol % or more and 11.0 vol % or less.

If the sum of Vemc, Vec, Vdmc, Vdec, Vpc, and Vfec were to be less than 97.0 vol %, and the content Vemc of ethyl methyl carbonate (1) is too small, the viscosity of the electrolyte solution 19 could increase, so that the electrical conductivity could decrease.

If the sum of Vemc, Vec, Vdmc, Vdec, Vpc, and Vfec were to be less than 97.0 vol % and the content Vec of ethylene carbonate (2) is too small, the relative permittivity of the electrolyte solution 19 could decrease. If the sum of Vemc, Vec, Vdmc, Vdec, Vpc, and Vfec were to be less than 97.0 vol %, and the content Vdmc of dimethyl carbonate (3) is too small, the viscosity of the electrolyte solution 19 could increase, so that the electrical conductivity could decrease.

In an implementation, the electrolyte in the electrolyte solution 19 may contain lithium hexafluorophosphate (LiPF₆), and a total concentration of the electrolyte in the electrolyte solution 19 may be, e.g., 1.05 mol/L or more and 1.60 mol/L or less, or 1.21 mol/L or more and 1.41 mol/L or less. When the total concentration of the electrolyte containing LiPF₆ is within the above ranges, the cycle characteristics of the lithium-ion secondary battery 100 at a high temperature may be improved. The electrical conductivity of the electrolyte solution 19 may vary depending on the concentration of the electrolyte. If the concentration of the electrolyte were to be too low, the electrical conductivity may not be sufficiently obtained. If the concentration of the electrolyte were to be too high, the electrical conductivity could decrease. The concentration of the electrolyte at which the electrical conductivity is maximized may vary depending on the type and mixing ratio of the electrolyte and the solvent. In an implementation, the electrolyte solution 19 may exhibit particularly high electrical conductivity in the range of 1.05 mol/L or more and 1.60 mol/L or less. In an implementation, e.g., other than LiPF₆, the electrolyte may include a lithium compound (lithium salt), e.g., LiClO₄, LiBF₄, LiCF₃SO₃, LiCF₃CF₂SO₃, LiC(CF₃SO₂)₃, LiN(CF₃SO₂)₂, LiN(CF₃CF₂SO₂)₂, LiN(CF₃SO₂)(C₄F₉SO₂), LiN(CF₃CF₂CO)₂, or LiBOB.

The first active material layer 14 (positive electrode active material layer) may contain a metal oxide as an active material, and the metal oxide may contain, e.g., lithium, nickel, manganese, and cobalt. An amount of nickel in the metal oxide is expressed as [Ni] mol. An amount of manganese in the metal oxide is expressed as [Mn] mol. An amount of cobalt in the metal oxide is expressed as [Co] mol. Among [Ni], [Mn], and [Co], [Ni] may be the largest, e.g., [Ni]>[Mn] and [Ni]>[Co]. In an implementation, [Ni]/[Mn] may be 1.55 or more and 2.15 or less, and [Ni]/[Co] may be 2.20 or more and 2.60 or less. In an implementation, [Ni]/[Mn] may be 3.00 or more and 8.00 or less, and [Ni]/[Co] may be 3.00 or more and 8.00 or less. As a result of studies by the inventors, it has been found that when the first active material layer 14 contains a metal oxide in which a part of cobalt in lithium cobaltate is replaced with manganese and nickel, the cycle characteristics of the lithium-ion secondary battery 100 at a high temperature may be easily improved by using the electrolyte solution 19 having the features (A), (B), (C), (D), (E), (F), and (G).

In the metal oxide contained in the first active material layer 14, when each of [Ni]/[Mn] and [Ni]/[Co] is within the above ranges, the cycle characteristics of the lithium-ion secondary battery 100 including the electrolyte solution 19 at a high temperature may be improved.

In an implementation, the metal oxide contained in the first active material layer 14 may be represented by the following Chemical Formula 1.

LiNiₓMn_{y}Co_{z}MₐO₂ (1)

The units of x, y, z, and a in Chemical Formula 1 are moles. x, y, z, and a in Chemical Formula 1 satisfy x+y+z+a=1. In an implementation, x in Chemical Formula 1 may satisfy 0<x<1. In an implementation, y in Chemical Formula 1 may satisfy 0<y<1. In an implementation, z in Chemical Formula 1 may satisfy 0<z<1. In an implementation, a in Chemical Formula 1 may satisfy 0≤a<1. M in Chemical Formula 1 may be, e.g., Al, Mg, Nb, Ti, Cu, Zn, or Cr. x/y calculated from x and y in Chemical Formula 1 is equal to [Ni]/[Mn]. x/z calculated from x and z in Chemical Formula 1 is equal to [Ni]/[Co].

In an implementation, the positive electrode active material contained in the first active material layer 14 may include, e.g., LiNiₓCo_{y}Mn_{z}MₐO₂, lithium nickelate (LiNiO₂), lithium manganate (LiMnO₂), lithium cobaltate (LiCoO₂), lithium manganese spinel (LiMn₂O₄), lithium vanadium compound (LiV₂O₅), olivine type LiMPO₄(M in LiPO₄ is Co, Ni, Mn, Fe, Mg, Nb, Ti, Al, and Zr, or VO), lithium titanate (Li₄Ti₅O₁₂), or LiNiₓCo_{y}Al_{z}O₂ (x, y, and z in LiNiₓCo_{y}Al_{z}O₂ satisfy 0.9<x+y+z<1.1).

The first active material layer 14 may further contain at least one element, e.g., sodium, aluminum, chlorine, phosphorus, or sulfur. In an implementation, sodium, aluminum, chlorine, phosphorus, or sulfur may be an inevitable impurity from the separator 18 or the electrolyte solution 19. In an implementation, sodium in the first active material layer 14 may be from an electrolyte, a positive electrode active material, or sodium contained as an impurity together with lithium in these raw materials. In an implementation, aluminum in the first active material layer 14 may be from aluminum contained in the separator 18 in contact with the first active material layer 14. In an implementation, extra gas may be generated from the electrolyte solution 19 by a side reaction associated with charging/discharging of the lithium-ion secondary battery 100 (the lithium-ion secondary battery 100 before the case 50 is sealed) before shipment, a solid electrolyte interphase film (SEI film) may be formed on the surface of the first active material layer 14, and chlorine, phosphorus, or sulfur from the electrolyte solution 19 may be incorporated into the first active material layer 14 according to these side reactions.

In an implementation, the first active material layer 14 may further contain conductive carbon such as graphite, acetylene black, or carbon black; metal powder such as copper, nickel, stainless steel, or iron; conductive polymer such as polyacetylene, polyaniline, polypyrrole, polythiophene, or polyacene; and at least one conductive material (conductive agent), e.g., a conductive oxide such as ITO.

The first active material layer 14 may further contain a binder (adhesive). In an implementation, the binder may include, e.g., polyvinylidene fluoride (PVDF), polytetrafluoroethylene (PTFE), vinylidene fluoride-hexafluoropropylene fluorine rubber (VDF-HFP fluorine rubber), vinylidene fluoride-hexafluoropropylene-tetrafluoroethylene fluorine rubber (VDF-HFP-TFE fluorine rubber), polyethylene, polypropylene, polyethylene terephthalate, aromatic polyamide, cellulose, styrene-butadiene rubber, isoprene rubber, butadiene rubber, ethylene-propylene rubber, a styrene-butadiene-styrene block copolymer, a hydrogenated product thereof, a styrene-ethylene-butadiene-styrene copolymer, a styrene-isoprene-styrene block copolymer, a hydrogenated product thereof, syndiotactic 1,2-polybutadiene, an ethylene-vinyl acetate copolymer, a propylene-α-olefin copolymer, or a conductive polymer.

In an implementation, the negative electrode active material contained in the second active material layer 24 may include, e.g., a carbon material such as natural graphite, artificial graphite, nongraphitizable carbon, easily graphitizable carbon, or low-temperature baked carbon; an amorphous compound such as a metal (Al, Sn, or the like) forming a compound with lithium or tin oxide; lithium titanate (Li₄Ti₅O₁₂), or TiO₂. The negative electrode active material may be a simple substance of silicon, an alloy containing silicon, or a compound containing silicon (oxide, silicate, or the like). In an implementation, the alloy containing silicon may contain tin (Sn), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb), or chromium (Cr). In an implementation, the compound containing silicon may include boron (B), nitrogen (N), oxygen (O), or carbon (C). In an implementation, the negative electrode active material containing silicon may include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₂N₂, Si₂N₂O, SiOₓ(x in SiOₓ satisfies 0<X≤2), or LiSiO. The negative electrode active material may be a fiber containing silicon (nanowire or the like) or a particle containing silicon (nanoparticle or the like).

In an implementation, the second active material layer 24 may further contain a conductive material (conductive agent). In an implementation, the second active material layer 24 may further contain a binder (adhesive).

The first current collector 12 (positive electrode current collector) may be a suitable conductor. The second current collector 22 (negative electrode current collector) may also be a suitable conductor. In an implementation, each of the first current collector 12 and the second current collector 22 may be a metal foil made of copper or aluminum. The surface of each of the first current collector 12 and the second current collector 22 may be treated by plating. In an implementation, the surface of each current collector treated by plating may contain nickel. The surface of each current collector treated by plating may further contain carbon, phosphorus, or tungsten, in addition to nickel. In an implementation, the positive electrode lead 62 and the negative electrode lead 60 may be a metal such as copper or aluminum.

In an implementation, the porous separator 18 may be a nonwoven fabric, a membrane, or a laminate. In an implementation, the separator 18 may be made of a polymer having electrical insulation properties. In an implementation, the separator 18 may contain a polymer, e.g., polyethylene, polypropylene, polyolefin, polyester, or cellulose.

In an implementation, the case 50 may be made of a metal such as aluminum and stainless steel. In an implementation, the case 50 may be made of a laminate film formed of a metal layer and a resin layer.

The power storage element such as the lithium-ion secondary battery 100 may be used for a suitable application. In an implementation, the power storage element may be used in a power supply of a mobile device such as a mobile phone, a smart watch, or a notebook computer, a power source of a transportation device such as an electric vehicle or a hybrid car, a stationary power storage device, or the like. The dimension and shape of the lithium-ion secondary battery 100 may be changed according to various applications. In an implementation, the thickness of each of the first current collector 12 and the second current collector 22 may be several μm or more and several ten μm or less. In an implementation, the thickness of each of the first active material layer 14 and the second active material layer 24 may be several μm or more and several hundred μm or less. In an implementation, the thickness of the separator 18 may be several μm or more and several hundred μm or less. The dimensions of the main surfaces of the first current collector 12, the separator 18, and the second current collector 22 may be substantially the same. In an implementation, the width of the main surface of each of the first current collector 12, the separator 18, and the second current collector 22 may be several ten mm or more and several hundred mm or less. In an implementation, the lithium-ion secondary battery 100 may be a wound battery, and the maximum width of the main surface of each of the first current collector 12, the separator 18, and the second current collector 22 may be about several thousand mm.

In an implementation, volatile components in the electrolyte solution 19 may be analyzed and specified by a method such as high performance gas chromatography and mass spectrometry. In an implementation, supporting salts (electrolytes) may be analyzed and specified by inductively coupled plasma emission spectroscopy. In an implementation, nonvolatile components in the electrolyte solution 19 may be analyzed and specified by nuclear magnetic resonance (NMR). In an implementation, a composition of each active material layer and each current collector may be analyzed and specified by a method such as inductively coupled plasma emission spectroscopy.

### [Lithium-Ion Secondary Battery Including Electrolyte Solution A]

Hereinafter, a lithium-ion secondary battery including an electrolyte solution A, which is an example of the electrolyte solution 19, will be described. The electrolyte solution A corresponds to the above-described [2] to [5], [11], and [14] to [17], and some of a plurality of examples described in Table 3, Table 4, Table 8, Table 10, and Table 11 described below.

The content Vemc of ethyl methyl carbonate (1) in the electrolyte solution A may be 27.0 vol % or more and 31.0 vol % or less.

The content Vec of ethylene carbonate (2) in the electrolyte solution A may be 29.0 vol % or more and 33.0 vol % or less.

The content Vdmc of dimethyl carbonate (3) in the electrolyte solution A may be 37.0 vol % or more and 41.0 vol % or less.

The content Vdec of diethyl carbonate (4) in the electrolyte solution A may be 0.02 vol % or more and 0.20 vol % or less.

The sum of Vemc, Vec, Vdmc, and Vdec in the electrolyte solution A may be 97.0 vol % or more and 100 vol % or less.

The lithium-ion secondary battery may contain the electrolyte solution A, and cycle characteristics of the lithium-ion secondary battery at a high temperature may be improved.

In the electrolyte solution A, Vemc may be smaller than Vec. When Vemc is smaller than Vec in the electrolyte solution A, the cycle characteristics of the lithium-ion secondary battery including the electrolyte solution A at a high temperature may be improved.

The content Mvc of the vinylene carbonate (6) in the electrolyte solution A may be 0.03 mass % or more and 0.20 mass % or less. Due to the vinylene carbonate (6), a thin SEI film may be easily formed on the surface of the negative electrode (second active material layer), and decomposition of the electrolyte solution A (nonaqueous solvent) on the surface of the negative electrode may be easily suppressed. When the content Mvc of the vinylene carbonate (6) in the electrolyte solution A is within the above range, the cycle characteristics of the lithium-ion secondary battery 100 including the electrolyte solution A at a high temperature may be improved. In an implementation, the content Mvc of the vinylene carbonate (6) in the electrolyte solution 19 having the features (A), (B), (C), (D), (E), (F), and (G) may also be 0.03 mass % or more and 0.20 mass % or less.

The content Mps of the propane sultone (7) in the electrolyte solution A may be 0.05 mass % or more and 0.20 mass % or less. Due to the propane sultone (7), a thin SEI film may be easily formed on the surface of the negative electrode, and decomposition of the electrolyte solution A (nonaqueous solvent) on the surface of the negative electrode may be easily suppressed. When the content Mps of the propane sultone (7) in the electrolyte solution A is 0.05 mass % or more and 0.20 mass % or less, the cycle characteristics of the lithium-ion secondary battery 100 including the electrolyte solution A at a high temperature may be improved. In an implementation, the content Mps of the propane sultone (7) in the electrolyte solution 19 having the features (A), (B), (C), (D), (E), (F), and (G) may also be 0.05 mass % or more and 0.20 mass % or less.

The electrolyte in the electrolyte solution A may contain lithium hexafluorophosphate (LiPF₆), and the total concentration of the electrolyte in the electrolyte solution A may be 1.05 mol/L or more and 1.20 mol/L or less. When the total concentration of the electrolyte containing LiPF₆ is 1.05 mol/L or more and 1.20 mol/L or less, the cycle characteristics of the lithium-ion secondary battery 100 including the electrolyte solution A at a high temperature may be improved. In an implementation, the electrolyte solution A may contain an electrolyte other than LiPF₆.

When the lithium-ion secondary battery contains the electrolyte solution A, [Ni]/[Mn] may be 1.67 or more and 1.84 or less in the metal oxide (active material) contained in the first active material layer 14 (positive electrode active material layer), and [Ni]/[Co] may be 2.21 or more and 2.41 or less in the metal oxide. When each of [Ni]/[Mn] and [Ni]/[Co] is within the above ranges, the cycle characteristics of the lithium-ion secondary battery 100 including the electrolyte solution A at a high temperature may be improved.

When the lithium-ion secondary battery contains the electrolyte solution A, the first active material layer (positive electrode active material layer) may further include titanium and zirconium. In an implementation, the first active material layer may further include TiO₂ and ZrO₂. When the first active material layer further includes titanium and zirconium, an effect of suppressing the decomposition of the electrolyte according to the side reaction on the surface of the first active material layer may be obtained. In an implementation, even when the electrolyte solution 19 having the features (A), (B), (C), (D), (E), (F) and (G) is included in the lithium-ion secondary battery, the first active material layer may further contain titanium and zirconium.

When the lithium-ion secondary battery includes the electrolyte solution A, the content of titanium in the first active material layer (positive electrode active material layer) may be 0.084 mol % or more and 0.184 mol % or less, or 0.10 mol % or more and 0.150 mol % or less in terms of TiO₂. For example, titanium may be included in the first active material layer in the form of TiO₂, such that an amount of the titanium (from the TiO₂) included in the first active material layer may be within the above ranges. When the content of titanium in the first active material layer is within the above ranges, the cycle characteristics of the lithium-ion secondary battery 100 including the electrolyte solution A at a high temperature may be improved. In an implementation, even when the electrolyte solution 19 having the features (A), (B), (C), (D), (E), (F) and (G) is included in the lithium-ion secondary battery, the content of titanium in the first active material layer may be within the above ranges.

When the lithium-ion secondary battery includes the electrolyte solution A, the content of zirconium in the first active material layer (positive electrode active material layer) may be 0.095 mol % or more and 0.195 mol % or less, or 0.10 mol % or more and 0.150 mol % or less in terms of ZrO₂. For example, zirconium may be included in the first active material layer in the form of ZrO₂, such that an amount of the zirconium (from the ZrO₂) included in the first active material layer may be within the above ranges. When the content of zirconium in the first active material layer is within the above ranges, the cycle characteristics of the lithium-ion secondary battery 100 including the electrolyte solution A at a high temperature may be improved. In an implementation, even when the electrolyte solution 19 having the features (A), (B), (C), (D), (E), (F) and (G) is included in the lithium-ion secondary battery, the content of zirconium in the first active material layer may be within the above range.

### [Lithium-Ion Secondary Battery Including Electrolyte Solution B]

Hereinafter, a lithium-ion secondary battery including an electrolyte solution B, which is an example of the electrolyte solution 19 having the features (A), (B), (C), (D), (E), (F), and (G), will be described. The lithium-ion secondary battery including the electrolyte solution B corresponds to the above-described [6] to [8], [12], and [18], and some of a plurality of examples described in Table 5, Table 6, Table 9, and Table 10 described below.

The content Vemc of the ethyl methyl carbonate (1) in the electrolyte solution B may be 40.5 vol % or more and 44.5 vol % or less.

The content Vec of the ethylene carbonate (2) in the electrolyte solution B may be 9.3 vol % or more and 13.3 vol % or less.

The content Vdmc of the dimethyl carbonate (3) in the electrolyte solution B may be 29.5 vol % or more and 33.5 vol % or less.

The content Vpc of the propylene carbonate (5) in the electrolyte solution B may be 4.0 vol % or more and 8.0 vol % or less.

The content Vfec of the fluoroethylene carbonate (8) in the electrolyte solution B may be 6.2 vol % or more and 10.8 vol % or less.

The sum of Vemc, Vec, Vdmc, Vpc, and Vfec in the electrolyte solution B may be 97.0 vol % or more and 100 vol % or less.

The lithium-ion secondary battery may include the electrolyte solution B, and the cycle characteristics of the lithium-ion secondary battery at a high temperature may be improved.

The content Mvc of the vinylene carbonate (6) in the electrolyte solution B may be 0.01 mass % or more and 0.10 mass % or less. Due to the vinylene carbonate (6), a thin SEI film may be easily formed on the surface of the negative electrode (second active material layer), and decomposition of the electrolyte solution B (nonaqueous solvent) on the surface of the negative electrode may be easily suppressed. When the content Mvc of the vinylene carbonate (6) in the electrolyte solution B is 0.01 mass % or more and 0.10 mass % or less, the cycle characteristics of the lithium-ion secondary battery 100 including the electrolyte solution B at a high temperature may be improved. In an implementation, the content Mvc of the vinylene carbonate (6) in the electrolyte solution 19 having the features (A), (B), (C), (D), (E), (F), and (G) may also be 0.01 mass % or more and 0.10 mass % or less.

The content Madn of the adiponitrile (9) in the electrolyte solution B may be 0.70 mass % or more and 4.70 mass % or less. Due to the adiponitrile (9), the structure of the lithium compound (positive electrode active material) contained in the positive electrode (first active material layer) may be stabilized, the side reaction of the positive electrode (first active material layer) and the electrolyte solution B may be suppressed, the life of the lithium-ion secondary battery charged at a high voltage may be extended, and the cycle characteristics of the lithium-ion secondary battery at a high temperature may be stabilized. When the content Madn of the adiponitrile (9) in the electrolyte solution B is 0.70 mass % or more and 4.70 mass % or less, the cycle characteristics of the lithium-ion secondary battery 100 including the electrolyte solution B at a high temperature may be improved. In an implementation, the content Madn of the adiponitrile (9) in the electrolyte solution 19 having the features (A), (B), (C), (D), (E), (F), and (G) may also be 0.70 mass % or more and 4.70 mass % or less.

The electrolyte in the electrolyte solution B may contain lithium hexafluorophosphate (LiPF₆), and the total concentration of the electrolyte in the electrolyte solution B may be 1.42 mol/L or more and 1.60 mol/L or less. When the total concentration of the electrolyte containing LiPF₆ is 1.42 mol/L or more and 1.60 mol/L or less, the cycle characteristics of the lithium-ion secondary battery 100 including the electrolyte solution B at a high temperature may be improved. In an implementation, the electrolyte solution B may contain an electrolyte other than LiPF₆.

When the lithium-ion secondary battery includes the electrolyte solution B, [Ni]/[Mn] may be 1.95 or more and 2.15 or less in the metal oxide (active material) contained in the first active material layer 14 (positive electrode active material layer), and [Ni]/[Co] may be 2.38 or more and 2.58 or less in the metal oxide. When each of [Ni]/[Mn] and [Ni]/[Co] is within the above ranges, the cycle characteristics of the lithium-ion secondary battery 100 including the electrolyte solution B at a high temperature may be improved.

The present disclosure is not necessarily limited to the above-described embodiments. Various modifications of the present disclosure are possible without departing from the gist of the present disclosure, and such modifications are also included in the present disclosure.

For example, the structure of the lithium-ion secondary battery may have a stricture that is different from the structure illustrated in the FIGURE. In an implementation, the lithium-ion secondary battery may be a wound battery. The wound battery may include a laminate in which a first separator, a positive electrode, a second separator, and a negative electrode are laminated in this order, and the wound laminate is housed in a case. The positive electrode of the wound battery may include a first current collector and a first active material layer covering both main surfaces of the first current collector. The negative electrode of the wound battery may include a second current collector and a second active material layer covering both main surfaces of the second current collector. Each of the first separator and the second separator may be impregnated with the electrolyte solution of the wound battery.

In an implementation, the power storage element may be something other than a lithium-ion secondary battery. In an implementation, the power storage element may be a sodium-ion secondary battery, a potassium-ion secondary battery, a magnesium-ion secondary battery, or a calcium-ion secondary battery.

### EXAMPLES

The present disclosure will be described in detail by the following Examples and Comparative Examples. The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

### <Production of Lithium-Ion Secondary Battery>

A lithium-ion battery of Example 1 was produced by the following method.

As the positive electrode active material contained in the first active material layer, a metal oxide represented by the following Chemical Formula 2 was used. x in the following Chemical Formula 2 was 6/10. y in the following Chemical Formula 2 was 2/10. z in the following Chemical Formula 2 was also 2/10. x+y+z was 1. x/y (that is, ([Ni]/[Mn]) was 3. x/z (that is, ([Ni]/[Co])) was also 3.

LiNiₓMn_{y}Co_{z}O₂ (2)

LiNiₓMn_{y}Co_{z}O₂, a conductive agent, a binder, and a solvent were mixed to prepare a positive electrode coating material (a raw material of the first active material layer). The positive electrode coating material was applied to the main surface of the first current collector. The first current collector covered with the positive electrode coating material was dried and rolled. Through the above steps, the positive electrode including the first active material layer and the first current collector was obtained. Carbon black was used as the conductive agent. As the binder, polyvinylidene fluoride was used. As the solvent, N-methyl-2 pyrrolidinone was used. As the first current collector, an aluminum foil was used. A ratio of the mass of LiNiₓMn_{y}Co_{z}O₂, the mass of the conductive agent, and the mass of the binder was 95.0:2.0:3.0.

A negative electrode coating material (raw material of the second active material layer) was prepared in a method similar to that in the positive electrode coating material, except that graphite was used instead of LiNiₓMn_{y}Co_{z}O₂. The negative electrode coating material was applied to the main surface of the second current collector. As the second current collector, a copper foil was used. The second current collector covered with the negative electrode coating material was dried and rolled. Through the above steps, the negative electrode including the second active material layer and the second current collector was obtained.

The separator was sandwiched between the first active material layer and the second active material layer, and the positive electrode, the negative electrode, and the separator were laminated in this order to obtain a power storage unit. The positive electrode, the negative electrode, and the separator were fixed to each other with a hot melt adhesive. As the separator, a porous membrane made of polyolefin was used. The dimensions of the main surfaces of the positive electrode, the negative electrode, and the separator were substantially the same. The positive electrode lead was connected to the positive electrode (first current collector) by ultrasonic welding. The negative electrode lead was connected to the negative electrode (second current collector) by a similar method. As the positive electrode lead, an aluminum foil was used. As the negative electrode lead, a nickel foil was used. A polymer for improving the sealability of the case was bonded to an end portion of each of the positive electrode lead and the negative electrode lead.

The power storage unit was housed in the case, and the electrolyte solution was injected into the case. In a state where the end portions of the positive electrode lead and the negative electrode lead insulated from each other were outside the case, the inside of the case was degassed, and the power storage unit and the electrolyte solution were sealed in the case. The case was made of a laminate film including a metal layer and a resin layer. Through the above steps, the lithium-ion secondary battery of Example 1 was obtained.

The electrolyte contained in the electrolyte solution of Example 1 was lithium hexafluorophosphate (LiPF₆). The concentration of LiPF₆ in the electrolyte solution of Example 1 was 1.0 mol/L.

A composition of the electrolyte solution of Example 1 is illustrated in the following Table 1.

Vemc described in the following Tables 1 to 9 means the content (unit: vol %) of ethyl methyl carbonate (1) in the electrolyte solution.

Vec described in the following Tables 1 to 9 means the content (unit: vol %) of ethylene carbonate (2) in the electrolyte solution.

Vdmc described in the following Tables 1 to 9 means the content (unit: vol %) of dimethyl carbonate (3) in the electrolyte solution.

Vdec described in the following Tables 1 to 9 means the content (unit: vol %) of diethyl carbonate (4) in the electrolyte solution.

Vpc described in the following Tables 1 to 9 means the content (unit: vol %) of propylene carbonate (5) in the electrolyte solution.

Vfec described in the following Tables 1 to 9 means the content (unit: vol %) of fluoroethylene carbonate (8) in the electrolyte solution.

Mvc described in the following Tables 1 to 9 means the content (unit: mass %) of vinylene carbonate (6) in the electrolyte solution.

Mps described in the following Tables 1 to 9 means the content (unit: mass %) of propane sultone (7) in the electrolyte solution.

Madn described in the following Tables 1 to 9 means the content (unit: mass %) of adiponitrile (9) in the electrolyte solution.

SUM1 described in the following Tables 1 to 9 means the sum (unit: vol %) of Vemc, Vec, Vdmc, Vdec, Vpc, and Vfec.

SUM2 described in the following Tables 3 and 4 means the sum (unit: vol %) of Vemc, Vec, Vdmc, and Vdec.

SUM6 described in the following Tables 5 and 6 means the sum (unit: vol %) of Vemc, Vec, Vdmc, Vpc, and Vfec.

### <Measurement of Capacity Retention Rate>

The charging/discharging cycle of the lithium-ion secondary battery of Example 1 was repeated 500 times. The discharging rate was maintained at 0.5 C. The temperature of the lithium-ion secondary battery in the charging/discharging cycle was maintained at 60° C. A capacity retention rate R_{CAPACITY} (unit: %) defined by the following Formula 1 was measured. C_{INITIAL} in the following Formula 1 is a discharging capacity (unit: mA·h/g) per unit mass of the lithium-ion secondary battery measured in the first charging/discharging cycle. C_{FINAL} in the following Formula 1 is a discharging capacity per unit mass of the lithium-ion secondary battery measured in the 500th charging/discharging cycle. The capacity retention rate of Example 1 is illustrated in the following Table 1.

$${R}_{CAPACITY} = ( {C}_{FINAL} / {C}_{INITIAL} ) \times 100 \qquad ( 1 )$$

A described in the column of “Evaluation” in the following Tables 1 to 11 means a capacity retention rate of 80% or more.

B described in the column of “Evaluation” in the following Tables 1 to 11 means a capacity retention rate of 75% or more and less than 80%.

C described in the column of “Evaluation” in the following Tables 1 to 11 means a capacity retention rate of 70% or more and less than 75%.

D described in the column of “Evaluation” in the following Tables 1 to 11 means a capacity retention rate of 65% or more and less than 70%.

E described in the column of “Evaluation” in the following Tables 1 to 11 means a capacity retention rate of 60% or more and less than 65%.

F described in the column of “Evaluation” in the following Tables 1 to 11 means a capacity retention rate of 55% or more and less than 60%.

G described in the column of “Evaluation” in the following Tables 1 to 11 means a capacity retention rate of 40% or less.

### Examples 2 to 79, 131, and 132 and Comparative Examples 1 to 12

The composition of the electrolyte solution of each of Examples 2 to 79, 131, and 132 and Comparative Examples 1 to 12 is illustrated in the following Tables 1 to 6. The lithium-ion secondary battery of each of Examples 2 to 79, 131, and 132 and Comparative Examples 1 to 12 was produced by a method similar to that in Example 1, except for the composition of the electrolyte solution. The capacity retention rate of the lithium-ion secondary battery of each of Examples 2 to 79, 131, and 132 and Comparative Examples 1 to 12 was measured by a method similar to that in Example 1. The capacity retention rate of the lithium-ion secondary battery of each of Examples 2 to 79, 131, and 132 and Comparative Examples 1 to 12 is illustrated in the following Tables 1 to 6.

### Examples 80 to 106

[LiPF₆] described in the following Tables 7 to 9 means the concentration (unit: mol/L) of LiPF₆ in the electrolyte solution. The concentration of LiPF₆ in the electrolyte solution of each of Examples 80 to 106 was adjusted to a value illustrated in the following Tables 7 to 9.

The electrolyte solution of each of Examples 80 to 88 in the following Table 7 was the same as the electrolyte solution of Example 2, except for the concentration of LiPF₆.

The electrolyte solution of each of Examples 89 to 97 in the following Table 8 was the same as the electrolyte solution of Example 46, except for the concentration of LiPF₆.

The electrolyte solution of each of Examples 98 to 106 in the following Table 9 was the same as the electrolyte solution of Example 79, except for the concentration of LiPF₆.

The lithium-ion secondary battery of each of Examples 80 to 106 were produced by a method similar to that in Example 1, except for the above matters. The capacity retention rate of the lithium-ion secondary battery of each of Examples 80 to 106 was measured by a method similar to that in Example 1. The capacity retention rate of the lithium-ion secondary battery of each of Examples 80 to 106 is illustrated in the following Tables 7 to 9.

### Examples 107 to 130

x/y (that is, [Ni]/[Mn]) in LiNiₓMn_{y}Co_{z}O₂ of each of Examples 107 to 130 was adjusted to a value illustrated in the following Tables 10 and 11. x/z (that is, [Ni]/[Co]) in LiNiₓMn_{y}Co_{z}O₂ of each of Examples 107 to 130 was adjusted to a value illustrated in the following Tables 10 and 11.

[Ti] described in the following Tables 10 and 11 is the content (unit: mol %) of titanium in the first active material layer, and is the content of titanium in terms of TiO₂.

[Zr] described in the following Tables 10 and 11 is the content (unit: mol %) of zirconium in the first active material layer, and is the content of zirconium in terms of ZrO₂.

At least one of TiO₂ and ZrO₂ was added to the raw material of the first active material layer of each of Examples 122 to 130. The content of titanium in the first active material layer of each of Examples 122 to 130 was adjusted to a value illustrated in the following Table 11. The content of zirconium in the first active material layer of each of Examples 122 to 130 was adjusted to a value illustrated in the following Table 11.

The electrolyte solution of each of Examples 107 to 130 was the same as the electrolyte solution of Example described in the column of “Electrolyte solution” in the following Tables 10 and 11.

The lithium-ion secondary battery of each of Examples 107 to 130 was produced by a method similar to that in Example 1, except for the above matters. The capacity retention rate of the lithium-ion secondary battery of each of Examples 107 to 130 was measured by a method similar to that in Example 1. The capacity retention rate of the lithium-ion secondary battery of each of Examples 107 to 130 is illustrated in the following Tables 10 and 11.

TABLE 1

| | (1) | (2) | (3) | (4) | (5) | (8) | (6) | (7) | (9) | | Capacity | |
|---|---|---|---|---|---|---|---|---|---|---|---|---|
| | Vemc | Vec | Vdmc | Vdec | Vpc | Vfec | Mvc | Mps | Madn | SUM1 | retention | |
| | Vol % | Vol % | Vol % | Vol % | Vol % | Vol % | mass % | mass % | mass % | Vol % | rate | Evaluation |
| Example 1 | 26.50 | 31.00 | 38.00 | 0.20 | 4.00 | 0.00 | 0.00 | 0.00 | 0.00 | 99.70 | 66% | D |
| Example 2 | 27.00 | 31.00 | 37.50 | 0.20 | 4.00 | 0.00 | 0.00 | 0.00 | 0.00 | 99.70 | 65% | D |
| Example 3 | 44.50 | 20.00 | 31.00 | 0.20 | 4.00 | 0.00 | 0.00 | 0.00 | 0.00 | 99.70 | 66% | D |
| Example 4 | 45.00 | 20.00 | 30.50 | 0.20 | 4.00 | 0.00 | 0.00 | 0.00 | 0.00 | 99.70 | 69% | D |
| Example 5 | 45.00 | 9.00 | 41.00 | 0.20 | 4.50 | 0.00 | 0.00 | 0.00 | 0.00 | 99.70 | 66% | D |
| Example 6 | 45.00 | 9.50 | 41.00 | 0.20 | 4.00 | 0.00 | 0.00 | 0.00 | 0.00 | 99.70 | 68% | D |
| Example 7 | 30.00 | 33.00 | 32.50 | 0.20 | 4.00 | 0.00 | 0.00 | 0.00 | 0.00 | 99.70 | 68% | D |
| Example 8 | 30.00 | 33.50 | 32.00 | 0.20 | 4.00 | 0.00 | 0.00 | 0.00 | 0.00 | 99.70 | 65% | D |
| Example 9 | 36.00 | 30.00 | 29.50 | 0.20 | 4.00 | 0.00 | 0.00 | 0.00 | 0.00 | 99.70 | 67% | D |
| Example 10 | 35.50 | 30.00 | 30.00 | 0.20 | 4.00 | 0.00 | 0.00 | 0.00 | 0.00 | 99.70 | 65% | D |
| Example 11 | 30.00 | 25.00 | 40.50 | 0.20 | 4.00 | 0.00 | 0.00 | 0.00 | 0.00 | 99.70 | 65% | D |
| Example 12 | 30.00 | 24.50 | 41.00 | 0.20 | 4.00 | 0.00 | 0.00 | 0.00 | 0.00 | 99.70 | 66% | D |
| Example 13 | 30.00 | 30.00 | 35.50 | 0.10 | 4.00 | 0.00 | 0.00 | 0.00 | 0.00 | 99.60 | 65% | D |
| Example 14 | 30.00 | 30.00 | 35.50 | 0.00 | 4.00 | 0.00 | 0.00 | 0.00 | 0.00 | 99.50 | 65% | D |
| Example 15 | 29.00 | 30.00 | 30.00 | 0.20 | 10.50 | 0.00 | 0.00 | 0.00 | 0.00 | 99.70 | 66% | D |
| Example 16 | 29.00 | 30.00 | 32.50 | 0.20 | 8.00 | 0.00 | 0.00 | 0.00 | 0.00 | 99.70 | 68% | D |
| Example 131 | 27.00 | 31.00 | 39.00 | 0.20 | 0.00 | 0.00 | 0.00 | 0.00 | 0.00 | 97.20 | 66% | D |
| Example 132 | 44.50 | 13.00 | 33.00 | 6.50 | 0.00 | 0.00 | 0.00 | 0.00 | 0.00 | 97.00 | 68% | D |

TABLE 2

| | (1) | (2) | (3) | (4) | (5) | (8) | (6) | (7) | (9) | | Capacity | |
|---|---|---|---|---|---|---|---|---|---|---|---|---|
| | Vemc | Vec | Vdmc | Vdec | Vpc | Vfec | Mvc | Mps | Madn | SUM1 | retention | |
| | Vol % | Vol % | Vol % | Vol % | Vol % | Vol % | mass % | mass % | mass % | Vol % | rate | Evaluation |
| Comparative example 1 | 26.00 | 33.00 | 32.00 | 0.20 | 8.00 | 0.00 | 0.00 | 0.00 | 0.00 | 99.20 | 35% | G |
| Comparative example 2 | 45.50 | 16.00 | 30.00 | 0.20 | 8.00 | 0.00 | 0.00 | 0.00 | 0.00 | 99.70 | 37% | G |
| Comparative example 3 | 42.00 | 8.50 | 41.00 | 0.20 | 8.00 | 0.00 | 0.00 | 0.00 | 0.00 | 99.70 | 34% | G |
| Comparative example 4 | 27.50 | 34.00 | 30.00 | 0.20 | 8.00 | 0.00 | 0.00 | 0.00 | 0.00 | 99.70 | 35% | G |
| Comparative example 5 | 29.50 | 33.00 | 29.00 | 0.20 | 8.00 | 0.00 | 0.00 | 0.00 | 0.00 | 99.70 | 38% | G |
| Comparative example 6 | 28.00 | 22.00 | 41.50 | 0.20 | 8.00 | 0.00 | 0.00 | 0.00 | 0.00 | 99.70 | 39% | G |
| Comparative example 7 | 28.00 | 33.00 | 30.00 | 0.25 | 8.00 | 0.00 | 0.00 | 0.00 | 0.00 | 99.25 | 37% | G |
| Comparative example 8 | 28.00 | 31.00 | 30.00 | 0.20 | 10.60 | 0.00 | 0.00 | 0.00 | 0.00 | 99.80 | 33% | G |
| Comparative example 9 | 45.50 | 8.50 | 37.50 | 0.20 | 8.00 | 0.00 | 0.00 | 0.00 | 0.00 | 99.70 | 32% | G |
| Comparative example 10 | 45.50 | 9.50 | 41.50 | 0.20 | 3.00 | 0.00 | 0.00 | 0.00 | 0.00 | 99.70 | 35% | G |
| Comparative example 11 | 41.50 | 8.50 | 41.50 | 0.20 | 8.00 | 0.00 | 0.00 | 0.00 | 0.00 | 99.70 | 34% | G |
| Comparative example 12 | 28.00 | 31.00 | 30.00 | 0.25 | 10.60 | 0.00 | 0.00 | 0.00 | 0.00 | 99.85 | 39% | G |

TABLE 3

| | (1) | (2) | (3) | (4) | (5) | (8) | (6) | (7) | (9) | | | Capacity | |
|---|---|---|---|---|---|---|---|---|---|---|---|---|---|
| | Vemc | Vec | Vdmc | Vdec | Vpc | Vfec | Mvc | Mps | Madn | SUM1 | SUM2 | retention | |
| | Vol % | Vol % | Vol % | Vol % | Vol % | Vol % | mass % | mass % | mass % | Vol % | Vol % | rate | Evaluation |
| Example 17 | 26.50 | 32.00 | 41.00 | 0.20 | 0.00 | 0.00 | 0.00 | 0.00 | 0.00 | 99.70 | 99.70 | 61% | E |
| Example 18 | 27.00 | 32.00 | 40.50 | 0.20 | 0.00 | 0.00 | 0.00 | 0.00 | 0.00 | 99.70 | 99.70 | 65% | D |
| Example 19 | 31.00 | 32.00 | 36.50 | 0.20 | 0.00 | 0.00 | 0.00 | 0.00 | 0.00 | 99.70 | 99.70 | 66% | D |
| Example 20 | 31.50 | 32.00 | 36.00 | 0.20 | 0.00 | 0.00 | 0.00 | 0.00 | 0.00 | 99.70 | 99.70 | 62% | E |
| Example 21 | 31.00 | 28.50 | 40.00 | 0.20 | 0.00 | 0.00 | 0.00 | 0.00 | 0.00 | 99.70 | 99.70 | 61% | E |
| Example 22 | 31.00 | 29.00 | 39.50 | 0.20 | 0.00 | 0.00 | 0.00 | 0.00 | 0.00 | 99.70 | 99.70 | 65% | D |
| Example 23 | 29.00 | 33.00 | 37.50 | 0.20 | 0.00 | 0.00 | 0.00 | 0.00 | 0.00 | 99.70 | 99.70 | 62% | E |
| Example 24 | 29.00 | 33.50 | 37.00 | 0.20 | 0.00 | 0.00 | 0.00 | 0.00 | 0.00 | 99.70 | 99.70 | 59% | F |
| Example 25 | 31.00 | 32.00 | 36.50 | 0.20 | 0.00 | 0.00 | 0.00 | 0.00 | 0.00 | 99.70 | 99.70 | 61% | E |
| Example 26 | 31.00 | 31.50 | 37.00 | 0.20 | 0.00 | 0.00 | 0.00 | 0.00 | 0.00 | 99.70 | 99.70 | 67% | D |
| Example 27 | 29.00 | 30.00 | 40.50 | 0.20 | 0.00 | 0.00 | 0.00 | 0.00 | 0.00 | 99.70 | 99.70 | 66% | D |
| Example 28 | 29.00 | 29.50 | 41.00 | 0.20 | 0.00 | 0.00 | 0.00 | 0.00 | 0.00 | 99.70 | 99.70 | 69% | D |
| Example 29 | 29.00 | 31.00 | 39.50 | 0.01 | 0.00 | 0.00 | 0.00 | 0.00 | 0.00 | 99.51 | 99.51 | 63% | E |
| Example 30 | 29.00 | 31.00 | 39.50 | 0.02 | 0.00 | 0.00 | 0.00 | 0.00 | 0.00 | 99.52 | 99.52 | 67% | D |
| Example 31 | 29.00 | 31.00 | 39.00 | 0.05 | 0.00 | 0.00 | 0.00 | 0.00 | 0.00 | 99.05 | 99.05 | 69% | D |
| Example 32 | 29.00 | 31.00 | 39.50 | 0.20 | 0.00 | 0.00 | 0.00 | 0.00 | 0.00 | 99.70 | 99.70 | 67% | D |

TABLE 4

| | (1) | (2) | (3) | (4) | (5) | (8) | (6) | (7) | (9) | | | Capacity | |
|---|---|---|---|---|---|---|---|---|---|---|---|---|---|
| | Vemc | Vec | Vdmc | Vdec | Vpc | Vfec | Mvc | Mps | Madn | SUM1 | SUM2 | retention | |
| | Vol % | Vol % | Vol % | Vol % | Vol % | Vol % | mass % | mass % | mass % | Vol % | Vol % | rate | Evaluation |
| Example 33 | 31.00 | 29.00 | 39.50 | 0.20 | 0.00 | 0.00 | 0.00 | 0.00 | 0.00 | 99.70 | 99.70 | 61% | E |
| Example 34 | 31.00 | 29.00 | 39.50 | 0.10 | 0.00 | 0.00 | 0.00 | 0.00 | 0.00 | 99.60 | 99.60 | 64% | E |
| Example 35 | 31.00 | 29.00 | 39.50 | 0.05 | 0.00 | 0.00 | 0.00 | 0.00 | 0.00 | 99.55 | 99.55 | 61% | E |
| Example 36 | 29.00 | 31.00 | 39.00 | 0.05 | 0.00 | 0.00 | 0.30 | 0.00 | 0.00 | 99.05 | 99.05 | 72% | C |
| Example 37 | 29.00 | 31.00 | 39.00 | 0.05 | 0.00 | 0.00 | 0.20 | 0.00 | 0.00 | 99.05 | 99.05 | 75% | B |
| Example 38 | 29.00 | 31.00 | 39.00 | 0.05 | 0.00 | 0.00 | 0.10 | 0.00 | 0.00 | 99.05 | 99.05 | 76% | B |
| Example 39 | 29.00 | 31.00 | 39.00 | 0.05 | 0.00 | 0.00 | 0.03 | 0.00 | 0.00 | 99.05 | 99.05 | 78% | B |
| Example 40 | 29.00 | 31.00 | 39.00 | 0.05 | 0.00 | 0.00 | 0.02 | 0.00 | 0.00 | 99.05 | 99.05 | 71% | C |
| Example 41 | 29.00 | 31.00 | 39.00 | 0.05 | 0.00 | 0.00 | 0.00 | 0.30 | 0.00 | 99.05 | 99.05 | 73% | C |
| Example 42 | 29.00 | 31.00 | 39.00 | 0.05 | 0.00 | 0.00 | 0.00 | 0.20 | 0.00 | 99.05 | 99.05 | 77% | B |
| Example 43 | 29.00 | 31.00 | 39.00 | 0.05 | 0.00 | 0.00 | 0.00 | 0.10 | 0.00 | 99.05 | 99.05 | 76% | B |
| Example 44 | 29.00 | 31.00 | 39.00 | 0.05 | 0.00 | 0.00 | 0.00 | 0.05 | 0.00 | 99.05 | 99.05 | 76% | B |
| Example 45 | 29.00 | 31.00 | 39.00 | 0.05 | 0.00 | 0.00 | 0.00 | 0.04 | 0.00 | 99.05 | 99.05 | 73% | C |
| Example 46 | 29.00 | 31.00 | 39.00 | 0.05 | 0.00 | 0.00 | 0.05 | 0.15 | 0.00 | 99.05 | 99.05 | 79% | B |
| Example 47 | 29.00 | 31.00 | 39.00 | 0.05 | 0.00 | 0.00 | 0.10 | 0.10 | 0.00 | 99.05 | 99.05 | 77% | B |

TABLE 5

| | (1) | (2) | (3) | (4) | (5) | (8) | (6) | (7) | (9) | | | Capacity | |
|---|---|---|---|---|---|---|---|---|---|---|---|---|---|
| | Vemc | Vec | Vdmc | Vdec | Vpc | Vfec | Mvc | Mps | Madn | SUM1 | SUM6 | retention | |
| | Vol % | Vol % | Vol % | Vol % | Vol % | Vol % | mass % | mass % | mass % | Vol % | Vol % | rate | Evaluation |
| Example 48 | 40.00 | 12.80 | 33.00 | 0.00 | 6.00 | 8.00 | 0.00 | 0.00 | 0.00 | 99.80 | 99.80 | 64% | D |
| Example 49 | 40.50 | 12.80 | 32.50 | 0.00 | 6.00 | 8.00 | 0.00 | 0.00 | 0.00 | 99.80 | 99.80 | 71% | C |
| Example 50 | 42.50 | 11.50 | 31.50 | 0.00 | 6.00 | 8.00 | 0.00 | 0.00 | 0.00 | 99.50 | 99.50 | 73% | C |
| Example 51 | 44.50 | 11.80 | 29.50 | 0.00 | 6.00 | 8.00 | 0.00 | 0.00 | 0.00 | 99.80 | 99.80 | 71% | C |
| Example 52 | 45.00 | 11.30 | 29.50 | 0.00 | 6.00 | 8.00 | 0.00 | 0.00 | 0.00 | 99.80 | 99.80 | 65% | D |
| Example 53 | 43.80 | 9.00 | 33.00 | 0.00 | 6.00 | 8.00 | 0.00 | 0.00 | 0.00 | 99.80 | 99.80 | 68% | D |
| Example 54 | 43.50 | 9.30 | 33.00 | 0.00 | 6.00 | 8.00 | 0.00 | 0.00 | 0.00 | 99.80 | 99.80 | 71% | C |
| Example 55 | 40.50 | 13.30 | 32.00 | 0.00 | 6.00 | 8.00 | 0.00 | 0.00 | 0.00 | 99.80 | 99.80 | 74% | C |
| Example 56 | 40.50 | 13.50 | 32.00 | 0.00 | 6.00 | 8.00 | 0.00 | 0.00 | 0.00 | 100.00 | 100.00 | 67% | D |
| Example 57 | 43.50 | 12.80 | 29.50 | 0.00 | 6.00 | 8.00 | 0.00 | 0.00 | 0.00 | 99.80 | 99.80 | 74% | C |
| Example 58 | 43.00 | 12.80 | 30.00 | 0.00 | 6.00 | 8.00 | 0.00 | 0.00 | 0.00 | 99.80 | 99.80 | 72% | C |
| Example 59 | 40.00 | 12.30 | 33.50 | 0.00 | 6.00 | 8.00 | 0.00 | 0.00 | 0.00 | 99.80 | 99.80 | 72% | C |
| Example 60 | 40.00 | 11.80 | 34.00 | 0.00 | 6.00 | 8.00 | 0.00 | 0.00 | 0.00 | 99.80 | 99.80 | 67% | D |
| Example 61 | 42.50 | 12.80 | 32.50 | 0.00 | 3.50 | 8.00 | 0.00 | 0.00 | 0.00 | 99.30 | 99.30 | 65% | D |
| Example 62 | 42.50 | 12.80 | 32.50 | 0.00 | 4.00 | 8.00 | 0.00 | 0.00 | 0.00 | 99.80 | 99.80 | 72% | C |
| Example 63 | 40.50 | 10.00 | 32.50 | 0.00 | 8.00 | 8.00 | 0.00 | 0.00 | 0.00 | 99.00 | 99.00 | 71% | C |
| Example 64 | 40.50 | 9.80 | 32.50 | 0.00 | 8.50 | 8.00 | 0.00 | 0.00 | 0.00 | 99.30 | 99.30 | 66% | D |

TABLE 6

| | (1) | (2) | (3) | (4) | (5) | (8) | (6) | (7) | (9) | | | Capacity | |
|---|---|---|---|---|---|---|---|---|---|---|---|---|---|
| | Vemc | Vec | Vdmc | Vdec | Vpc | Vfec | Mvc | Mps | Madn | SUM1 | SUM6 | retention | |
| | Vol % | Vol % | Vol % | Vol % | Vol % | Vol % | mass % | mass % | mass % | Vol % | Vol % | rate | Evaluation |
| Example 65 | 42.50 | 12.80 | 32.50 | 0.00 | 6.00 | 6.00 | 0.00 | 0.00 | 0.00 | 99.80 | 99.80 | 69% | D |
| Example 66 | 42.50 | 12.80 | 32.50 | 0.00 | 6.00 | 6.20 | 0.00 | 0.00 | 0.00 | 100.00 | 100.00 | 72% | C |
| Example 67 | 40.50 | 10.00 | 32.50 | 0.00 | 6.00 | 10.80 | 0.00 | 0.00 | 0.00 | 99.80 | 99.80 | 73% | C |
| Example 68 | 40.50 | 9.80 | 32.50 | 0.00 | 6.00 | 11.00 | 0.00 | 0.00 | 0.00 | 99.80 | 99.80 | 68% | D |
| Example 69 | 42.50 | 11.50 | 31.50 | 0.00 | 6.00 | 8.00 | 0.01 | 0.00 | 0.00 | 99.50 | 99.50 | 73% | C |
| Example 70 | 42.50 | 11.50 | 31.50 | 0.00 | 6.00 | 8.00 | 0.05 | 0.00 | 0.00 | 99.50 | 99.50 | 77% | B |
| Example 71 | 42.50 | 11.50 | 31.50 | 0.00 | 6.00 | 8.00 | 0.10 | 0.00 | 0.00 | 99.50 | 99.50 | 76% | B |
| Example 72 | 42.50 | 11.50 | 31.50 | 0.00 | 6.00 | 8.00 | 0.20 | 0.00 | 0.00 | 99.50 | 99.50 | 70% | C |
| Example 73 | 42.50 | 11.50 | 31.50 | 0.00 | 6.00 | 8.00 | 0.00 | 0.00 | 0.50 | 99.50 | 99.50 | 71% | C |
| Example 74 | 42.50 | 11.50 | 31.50 | 0.00 | 6.00 | 8.00 | 0.00 | 0.00 | 0.70 | 99.50 | 99.50 | 76% | B |
| Example 75 | 42.50 | 11.50 | 31.50 | 0.00 | 6.00 | 8.00 | 0.00 | 0.00 | 2.00 | 99.50 | 99.50 | 76% | B |
| Example 76 | 42.50 | 11.50 | 31.50 | 0.00 | 6.00 | 8.00 | 0.00 | 0.00 | 4.70 | 99.50 | 99.50 | 77% | B |
| Example 77 | 42.50 | 11.50 | 31.50 | 0.00 | 6.00 | 8.00 | 0.00 | 0.00 | 5.00 | 99.50 | 99.50 | 70% | C |
| Example 78 | 42.50 | 11.30 | 31.50 | 0.00 | 6.00 | 8.50 | 0.03 | 0.00 | 2.70 | 99.80 | 99.80 | 78% | B |
| Example 79 | 42.50 | 11.30 | 31.50 | 0.00 | 6.00 | 8.60 | 0.10 | 0.00 | 2.00 | 99.90 | 99.90 | 76% | B |

TABLE 7

| | (1) | (2) | (3) | (4) | (5) | (8) | (6) | (7) | (9) | | | Capacity | |
|---|---|---|---|---|---|---|---|---|---|---|---|---|---|
| | Vemc | Vec | Vdmc | Vdec | Vpc | Vfec | Mvc | Mps | Madn | [LiPF₆] | SUM1 | retention | |
| | Vol % | Vol % | Vol % | Vol % | Vol % | Vol % | mass % | mass % | mass % | mol/L | Vol % | rate | Evaluation |
| Example 80 | 27.00 | 31.00 | 37.50 | 0.20 | 4.00 | 0.00 | 0.00 | 0.00 | 0.00 | 1.05 | 99.70 | 71% | C |
| Example 81 | 27.00 | 31.00 | 37.50 | 0.20 | 4.00 | 0.00 | 0.00 | 0.00 | 0.00 | 1.10 | 99.70 | 74% | C |
| Example 82 | 27.00 | 31.00 | 37.50 | 0.20 | 4.00 | 0.00 | 0.00 | 0.00 | 0.00 | 1.20 | 99.70 | 72% | C |
| Example 83 | 27.00 | 31.00 | 37.50 | 0.20 | 4.00 | 0.00 | 0.00 | 0.00 | 0.00 | 1.21 | 99.70 | 77% | B |
| Example 84 | 27.00 | 31.00 | 37.50 | 0.20 | 4.00 | 0.00 | 0.00 | 0.00 | 0.00 | 1.40 | 99.70 | 76% | B |
| Example 85 | 27.00 | 31.00 | 37.50 | 0.20 | 4.00 | 0.00 | 0.00 | 0.00 | 0.00 | 1.41 | 99.70 | 76% | B |
| Example 86 | 27.00 | 31.00 | 37.50 | 0.20 | 4.00 | 0.00 | 0.00 | 0.00 | 0.00 | 1.42 | 99.70 | 72% | C |
| Example 87 | 27.00 | 31.00 | 37.50 | 0.20 | 4.00 | 0.00 | 0.00 | 0.00 | 0.00 | 1.60 | 99.70 | 72% | C |
| Example 88 | 27.00 | 31.00 | 37.50 | 0.20 | 4.00 | 0.00 | 0.00 | 0.00 | 0.00 | 1.65 | 99.70 | 68% | D |

TABLE 8

| | (1) | (2) | (3) | (4) | (5) | (8) | (6) | (7) | (9) | | | Capacity | |
|---|---|---|---|---|---|---|---|---|---|---|---|---|---|
| | Vemc | Vec | Vdmc | Vdec | Vpc | Vfec | Mvc | Mps | Madn | [LiPF₆] | SUM1 | retention | |
| | Vol % | Vol % | Vol % | Vol % | Vol % | Vol % | mass % | mass % | mass % | mol/L | Vol % | rate | Evaluation |
| Example 89 | 29.00 | 31.00 | 39.00 | 0.05 | 0.00 | 0.00 | 0.05 | 0.15 | 0.00 | 1.05 | 99.05 | 81% | A |
| Example 90 | 29.00 | 31.00 | 39.00 | 0.05 | 0.00 | 0.00 | 0.05 | 0.15 | 0.00 | 1.10 | 99.05 | 80% | A |
| Example 91 | 29.00 | 31.00 | 39.00 | 0.05 | 0.00 | 0.00 | 0.05 | 0.15 | 0.00 | 1.20 | 99.05 | 82% | A |
| Example 92 | 29.00 | 31.00 | 39.00 | 0.05 | 0.00 | 0.00 | 0.05 | 0.15 | 0.00 | 1.21 | 99.05 | 78% | B |
| Example 93 | 29.00 | 31.00 | 39.00 | 0.05 | 0.00 | 0.00 | 0.05 | 0.15 | 0.00 | 1.40 | 99.05 | 78% | B |
| Example 94 | 29.00 | 31.00 | 39.00 | 0.05 | 0.00 | 0.00 | 0.05 | 0.15 | 0.00 | 1.41 | 99.05 | 76% | B |
| Example 95 | 29.00 | 31.00 | 39.00 | 0.05 | 0.00 | 0.00 | 0.05 | 0.15 | 0.00 | 1.42 | 99.05 | 77% | B |
| Example 96 | 29.00 | 31.00 | 39.00 | 0.05 | 0.00 | 0.00 | 0.05 | 0.15 | 0.00 | 1.60 | 99.05 | 75% | B |
| Example 97 | 29.00 | 31.00 | 39.00 | 0.05 | 0.00 | 0.00 | 0.05 | 0.15 | 0.00 | 1.65 | 99.05 | 70% | C |

TABLE 9

| | (1) | (2) | (3) | (4) | (5) | (8) | (6) | (7) | (9) | | | Capacity | |
|---|---|---|---|---|---|---|---|---|---|---|---|---|---|
| | Vemc | Vec | Vdmc | Vdec | Vpc | Vfec | Mvc | Mps | Madn | [LiPF₆] | SUM1 | retention | |
| | Vol % | Vol % | Vol % | Vol % | Vol % | Vol % | mass % | mass % | mass % | mol/L | Vol % | rate | Evaluation |
| Example 98 | 42.50 | 11.30 | 31.50 | 0.00 | 6.00 | 8.60 | 0.10 | 0.00 | 2.00 | 1.05 | 99.90 | 78% | B |
| Example 99 | 42.50 | 11.30 | 31.50 | 0.00 | 6.00 | 8.60 | 0.10 | 0.00 | 2.00 | 1.10 | 99.90 | 76% | B |
| Example 100 | 42.50 | 11.30 | 31.50 | 0.00 | 6.00 | 8.60 | 0.10 | 0.00 | 2.00 | 1.20 | 99.90 | 79% | B |
| Example 101 | 42.50 | 11.30 | 31.50 | 0.00 | 6.00 | 8.60 | 0.10 | 0.00 | 2.00 | 1.21 | 99.90 | 79% | B |
| Example 102 | 42.50 | 11.30 | 31.50 | 0.00 | 6.00 | 8.60 | 0.10 | 0.00 | 2.00 | 1.40 | 99.90 | 76% | B |
| Example 103 | 42.50 | 11.30 | 31.50 | 0.00 | 6.00 | 8.60 | 0.10 | 0.00 | 2.00 | 1.41 | 99.90 | 76% | B |
| Example 104 | 42.50 | 11.30 | 31.50 | 0.00 | 6.00 | 8.60 | 0.10 | 0.00 | 2.00 | 1.42 | 99.90 | 82% | A |
| Example 105 | 42.50 | 11.30 | 31.50 | 0.00 | 6.00 | 8.60 | 0.10 | 0.00 | 2.00 | 1.60 | 99.90 | 83% | A |
| Example 106 | 42.50 | 11.30 | 31.50 | 0.00 | 6.00 | 8.60 | 0.10 | 0.00 | 2.00 | 1.65 | 99.90 | 78% | C |

TABLE 10

| | | | | | | Capacity | |
|---|---|---|---|---|---|---|---|
| | LiNiₓMn_{y}Co_{z}O₂ | | [Ti] | [Zr] | Electrolyte | retention | |
| | x/y | x/z | mol % | mol % | solution | rate | Evaluation |
| Example 107 | 1.67 | 2.50 | 0.00 | 0.00 | Example 2 | 68% | D |
| Example 108 | 2.08 | 2.48 | 0.00 | 0.00 | Example 2 | 69% | D |
| Example 109 | 1.75 | 2.33 | 0.00 | 0.00 | Example 2 | 66% | D |
| Example 110 | 1.67 | 2.50 | 0.00 | 0.00 | Example 46 | 76% | B |
| Example 111 | 2.08 | 2.48 | 0.00 | 0.00 | Example 46 | 76% | B |
| Example 112 | 1.75 | 2.33 | 0.00 | 0.00 | Example 46 | 82% | A |
| Example 113 | 1.67 | 2.50 | 0.00 | 0.00 | Example 79 | 78% | B |
| Example 114 | 2.08 | 2.48 | 0.00 | 0.00 | Example 79 | 81% | A |
| Example 115 | 1.75 | 2.33 | 0.00 | 0.00 | Example 79 | 77% | B |
| Example 116 | 4.67 | 4.67 | 0.00 | 0.00 | Example 2 | 68% | D |
| Example 117 | 4.67 | 4.67 | 0.00 | 0.00 | Example 46 | 76% | B |
| Example 118 | 4.67 | 4.67 | 0.00 | 0.00 | Example 79 | 77% | B |
| Example 119 | 8.00 | 8.00 | 0.00 | 0.00 | Example 2 | 65% | D |
| Example 120 | 8.00 | 8.00 | 0.00 | 0.00 | Example 46 | 75% | B |
| Example 121 | 8.00 | 8.00 | 0.00 | 0.00 | Example 79 | 78% | B |

TABLE 11

| | | | | | | Capacity | |
|---|---|---|---|---|---|---|---|
| | LiNiₓMn_{y}Co_{z}O₂ | | [Ti] | [Zr] | Electrolyte | retention | |
| | x/y | x/z | mol % | mol % | solution | rate | Evaluation |
| Example 122 | 1.75 | 2.33 | 0.05 | 0.00 | Example 46 | 81% | A |
| Example 123 | 1.75 | 2.33 | 0.15 | 0.00 | Example 46 | 82% | A |
| Example 124 | 1.75 | 2.33 | 0.00 | 0.05 | Example 46 | 81% | A |
| Example 125 | 1.75 | 2.33 | 0.00 | 0.15 | Example 46 | 84% | A |
| Example 126 | 1.75 | 2.33 | 0.01 | 0.01 | Example 46 | 81% | A |
| Example 127 | 1.75 | 2.33 | 0.05 | 0.05 | Example 46 | 80% | A |
| Example 128 | 1.75 | 2.33 | 0.10 | 0.10 | Example 46 | 86% | A |
| Example 129 | 1.75 | 2.33 | 0.15 | 0.15 | Example 46 | 87% | A |
| Example 130 | 1.75 | 2.33 | 0.20 | 0.20 | Example 46 | 82% | A |

### INDUSTRIAL APPLICABILITY

A power storage element according to one aspect of the present disclosure may be used in a power supply of a mobile device such as a mobile phone, a smart watch, or a notebook computer, a power source of a transportation device such as an electric vehicle or a hybrid car, a stationary power storage device, and the like.

### REFERENCE SIGNS LIST

10: Positive electrode, 12: First current collector, 14: First active material layer, 18: Separator, 19: Electrolyte solution, 20: Negative electrode, 22: Second current collector, 24: Second active material layer, 30: Power storage unit, 50: Case, 60: Negative electrode lead, 62: Positive electrode lead, 100: Lithium-ion secondary battery (power storage element).

1. A power storage element, comprising:
a positive electrode;
a negative electrode;
a separator; and
an electrolyte solution, wherein
the positive electrode includes a first current collector and a first active material layer covering at least a part of a main surface of the first current collector,
the negative electrode includes a second current collector and a second active material layer covering at least a part of a main surface of the second current collector,
the first active material layer and the second active material layer face each other with the separator therebetween,
the separator is a porous insulator, and is between the first active material layer and the second active material layer,
the separator is impregnated with the electrolyte solution, and the electrolyte solution is in contact with the first active material layer and the second active material layer,
a content Vemc of ethyl methyl carbonate in the electrolyte solution is 26.5 vol % or more and 45.0 vol % or less,
a content Vec of ethylene carbonate in the electrolyte solution is 9.0 vol % or more and 33.5 vol % or less,
a content Vdmc of dimethyl carbonate in the electrolyte solution is 29.5 vol % or more and 41.0 vol % or less,
a content Vdec of diethyl carbonate in the electrolyte solution is 0.0 vol % or more and 0.2 vol % or less,
a content Vpc of propylene carbonate in the electrolyte solution is 0.0 vol % or more and 10.5 vol % or less,
a content Vfec of fluoroethylene carbonate in the electrolyte solution is 0.0 vol % or more, and
a sum of Vemc, Vec, Vdmc, Vdec, Vpc, and Vfec is 97.0 vol % or more and 100 vol % or less.

2. The power storage element according to claim 1, wherein:
Vemc is 27.0 vol % or more and 31.0 vol % or less,
Vec is 29.0 vol % or more and 33.0 vol % or less,
Vdmc is 37.0 vol % or more and 41.0 vol % or less,
Vdec is 0.02 vol % or more and 0.20 vol % or less, and
a sum of Vemc, Vec, Vdmc, and Vdec is 97.0 vol % or more and 100 vol % or less.

3. The power storage element according to claim 2, wherein Vemc is smaller than Vec.

4. The power storage element according to claim 2, wherein:
the electrolyte solution further includes vinylene carbonate, and
a content of vinylene carbonate in the electrolyte solution is 0.03 mass % or more and 0.20 mass % or less, based on a total mass of the electrolyte solution.

5. The power storage element according to claim 2, wherein:
the electrolyte solution further includes propane sultone, and
a content of propane sultone in the electrolyte solution is 0.05 mass % or more and 0.20 mass % or less, based on a total mass of the electrolyte solution.

6. The power storage element according to claim 1, wherein:
Vemc is 40.5 vol % or more and 44.5 vol % or less,
Vec is 9.3 vol % or more and 13.3 vol % or less,
Vdmc is 29.5 vol % or more and 33.5 vol % or less,
Vpc is 4.0 vol % or more and 8.0 vol % or less,
Vfec is 6.2 vol % or more and 10.8 vol % or less, and
a sum of Vemc, Vec, Vdmc, Vpc, and Vfec is 97.0 vol % or more and 100 vol % or less.

7. The power storage element according to claim 6, wherein:
the electrolyte solution further includes vinylene carbonate, and
a content of vinylene carbonate in the electrolyte solution is 0.01 mass % or more and 0.10 mass % or less, based on a total mass of the electrolyte solution.

8. The power storage element according to claim 6, wherein:
the electrolyte solution further includes adiponitrile, and
a content of adiponitrile in the electrolyte solution is 0.70 mass % or more and 4.70 mass % or less, based on a total mass of the electrolyte solution.

9. The power storage element according to claim 1, wherein:
the electrolyte solution includes lithium hexafluorophosphate as an electrolyte, and
a total concentration of the electrolyte in the electrolyte solution is 1.05 mol/L or more and 1.60 mol/L or less.

10. The power storage element according to claim 1, wherein:
the electrolyte solution includes lithium hexafluorophosphate as an electrolyte, and
a total concentration of the electrolyte in the electrolyte solution is 1.21 mol/L or more and 1.41 mol/L or less.

11. The power storage element according to claim 2, wherein:
the electrolyte solution includes lithium hexafluorophosphate as an electrolyte, and
a total concentration of the electrolyte in the electrolyte solution is 1.05 mol/L or more and 1.20 mol/L or less.

12. The power storage element according to claim 6, wherein:
the electrolyte solution includes lithium hexafluorophosphate as an electrolyte, and
a total concentration of the electrolyte in the electrolyte solution is 1.42 mol/L or more and 1.60 mol/L or less.

13. The power storage element according to claim 1, wherein:
the first active material layer includes a metal oxide,
the metal oxide contains lithium, nickel, manganese, and cobalt,
an amount of nickel in the metal oxide is expressed as [Ni] mol,
an amount of manganese in the metal oxide is expressed as [Mn] mol,
an amount of cobalt in the metal oxide is expressed as [Co] mol,
among the [Ni], the [Mn], and the [Co], the [Ni] is largest,
[Ni]/[Mn] is 1.55 or more and 2.15 or less, and
[Ni]/[Co] is 2.20 or more and 2.60 or less.

14. The power storage element according to claim 2, wherein:
the first active material layer includes a metal oxide,
the metal oxide contains lithium, nickel, manganese, and cobalt,
an amount of nickel in the metal oxide is expressed as [Ni] mol,
an amount of manganese in the metal oxide is expressed as [Mn] mol,
an amount of cobalt in the metal oxide is expressed as [Co] mol,
among the [Ni], the [Mn], and the [Co], the [Ni] is largest,
[Ni]/[Mn] is 1.67 or more and 1.84 or less, and
[Ni]/[Co] is 2.21 or more and 2.41 or less.

15. The power storage element according to claim 14, wherein the first active material layer further includes titanium and zirconium.

16. The power storage element according to claim 15, wherein a content of the titanium in the first active material layer is 0.084 mol % or more and 0.184 mol % or less in terms of TiO₂.

17. The power storage element according to claim 15, wherein a content of the zirconium in the first active material layer is 0.095 mol % or more and 0.195 mol % or less in terms of ZrO₂.

18. The power storage element according to claim 6, wherein:
the first active material layer includes a metal oxide,
the metal oxide contains lithium, nickel, manganese, and cobalt,
an amount of nickel in the metal oxide is expressed as [Ni] mol,
an amount of manganese in the metal oxide is expressed as [Mn] mol,
an amount of cobalt in the metal oxide is expressed as [Co] mol,
among the [Ni], the [Mn], and the [Co], the [Ni] is largest,
[Ni]/[Mn] is 1.95 or more and 2.15 or less, and
[Ni]/[Co] is 2.38 or more and 2.58 or less.

19. The power storage element according to claim 13, wherein the first active material layer further includes sodium, aluminum, chlorine, phosphorus, or sulfur.

20. The power storage element according to claim 1, wherein:
the first active material layer includes a metal oxide,
the metal oxide contains lithium, nickel, manganese, and cobalt,
an amount of nickel in the metal oxide is expressed as [Ni] mol,
an amount of manganese in the metal oxide is expressed as [Mn]mol,
an amount of cobalt in the metal oxide is expressed as [Co] mol,
among the [Ni], the [Mn], and the [Co], the [Ni] is largest,
[Ni]/[Mn] is 3.00 or more and 8.00 or less, and
[Ni]/[Co] is 3.00 or more and 8.00 or less.
